(19) United States
(12) Patent Application Publication
(10) Pub. No.: US 2025/0350587 A1
(43) Pub. Date: Nov. 13, 2025

(54) MACHINE OPERATION SYSTEM USING WIRED COMMUNICATION AND WIRELESS COMMUNICATION

(71) Applicant: Fanuc Corporation, Minamitsuru-gun, Yamanashi (JP)

(72) Inventor: Gou INABA, Minamitsuru-gun, Yamanashi (JP)

(73) Assignee: Fanuc Corporation, Minamitsuru-gun, Yamanashi (JP)

(21) Appl. No.: 18/866,756

(22) PCT Filed: May 31, 2022
(86) PCT No.: PCT/JP2022/022199

§ 371 Date: Nov. 18, 2024

(51) Int. Cl. H04L 9/40; G05B 19/42

(52) U.S. Cl. CPC H04L 63/08; G05B 19/42; H04L 63/18; G05B 2219/33192; G05B 2219/36159

(57) ABSTRACT

This machine operation system includes: a wireless operation device that is connected via wireless communication with a control device of a robot or an industrial machine, and that issues a command, in accordance with operation content, to the control device to move the robot or the industrial machine; a wired operation device that is connected via wired communication with the control device, and that transmits a signal to the control device in accordance with the operation content; and an authentication unit that enables the operation content for the wireless operation device if a first operation for the wired operation device and a second operation for the wireless operation device are executed simultaneously or in a predetermined order.

### CROSS REFERENCE TO RELATED APPLICATIONS

This is the U.S. National Phase application of PCT/JP2022/022199, filed May 31, 2022, the disclosure of this application being incorporated herein by reference in its entirety for all purposes.

### FIELD OF THE INVENTION

The present invention relates to a machine operation system using wired communication and wireless communication.

### BACKGROUND OF THE INVENTION

In order to manually operate a robot or an industrial machine, a teaching operation device referred to as a teaching pendant connected to a control device of the robot or the industrial machine is used. A worker can perform registration, editing, condition setting, and state display of a motion program related to the robot or the industrial machine, teaching of the robot or the industrial machine, and the like by using the teaching operation device. In order to avoid an unexpected motion of the robot or a machine tool and secure safety of a surrounding machine and a surrounding worker, a safety switch such as an enable switch and an emergency stop button is provided in the teaching operation device.

Further, in recent years, a teaching operation device that manually operates a robot and an industrial machine by a general-purpose information terminal such as a tablet is used instead of hardware dedicated to the teaching operation device in terms of cost reduction, securing of versatility, and the like, and the safety switch also needs to be provided in such a teaching operation device.

For example, an industrial robot operation device has been known that outputs a motion signal for causing a robot to perform a motion, based on an input operation by a worker and provides the motion signal to a robot controller, and includes: a portable operation terminal that includes a touch panel portion for display and input, and outputs the motion signal by the worker performing an input operation of the touch panel portion; and a base member disposed in such a way that the operation terminal can be removably attached and the touch panel portion is exposed to the outside, the base member includes: a grip portion being provided upright from a bottom plate facing a back surface of the operation terminal, and being held by one hand when the worker performs the input operation by the other hand; and an enable switch provided in an operable position by the hand holding the grip portion while the grip portion is held, and the industrial robot operation device further includes a detection means for detecting that the operation terminal is disposed on the base member (for example, see PTL 1).

For example, an emergency stop switch has been known that includes: a switch main body portion that is connected to a robot controller for controlling driving of a robot in a wired manner, and switches the control of the robot controller to an emergency stop state in response to an operation of a user; an attachment portion that removably attaches the switch main body portion to a portable terminal that accepts the operation of the user; and an identification code portion that is provided in a position facing a lens of a camera included in the portable terminal when the attachment portion is attached to the portable terminal, and displays an identification code that identifies the switch main body portion in a manner in which the identification code can be captured by the camera (for example, see PTL 2).

### PATENT LITERATURE

[PTL 1] JP 2021-164995A

[PTL 2] JP 2022-028062A

### SUMMARY OF THE INVENTION

In a machine operation system as a teaching operation device using a general-purpose information terminal, a base member provided with a safety switch is attached to the general-purpose information terminal. The general-purpose information terminal is connected to a control device of a robot or an industrial machine via wireless communication, whereas the base member is connected to the control device of the robot or the industrial machine via wired communication, and safety is generally secured. However, the general-purpose information terminal and the base member can be removably attached to each other, and thus, when the general-purpose information terminal and the base member are separated and located at different places, a teaching worker with the general-purpose information terminal cannot operate the safety switch on his/her own decision, or the safety switch may be operated by a third person different from the teaching worker, and safety cannot be secured. In the machine operation system formed of the general-purpose information terminal and the base member including the safety switch, the machine operation system that can secure safety at a low cost is desired.

According to one aspect of the present disclosure, a machine operation system includes: a wireless operation device that is connected to a control device of a robot or an industrial machine via wireless communication, and commands a motion of the robot or the industrial machine to the control device in response to an operation content; a wired operation device that is connected to the control device via wired communication, and transmits a signal to the control device in response to an operation content; and an authentication unit configured to enable an operation content for the wireless operation device when a first operation on the wired operation device and a second operation on the wireless operation device are performed simultaneously or in a predetermined order.

According to one aspect of the present disclosure, in a machine operation system formed of a general-purpose information terminal and a base member including a safety switch, safety can be secured at a low cost.

### BRIEF DESCRIPTION OF DRAWINGS

FIG. 1 is a diagram illustrating a machine operation system according to one embodiment of the present disclosure.

FIG. 2 is a flowchart illustrating a motion flow of the machine operation system according to one embodiment of the present disclosure.

FIG. 3 is a diagram illustrating a first aspect of the machine operation system according to one embodiment of the present disclosure.

FIG. 4 is a diagram illustrating a second aspect of the machine operation system according to one embodiment of the present disclosure.

FIG. 5 is a diagram illustrating a third aspect of the machine operation system according to one embodiment of the present disclosure.

FIG. 6 is a diagram illustrating a fourth aspect of the machine operation system according to one embodiment of the present disclosure.

FIG. 7 is a diagram illustrating an authentication button provided in the machine operation system according to one embodiment of the present disclosure.

FIG. 8 is a diagram illustrating a fifth aspect of the machine operation system according to one embodiment of the present disclosure.

FIG. 9 is a flowchart illustrating a motion flow of a sixth aspect of the machine operation system according to one embodiment of the present disclosure.

FIG. 10 is a diagram illustrating the sixth aspect of the machine operation system according to one embodiment of the present disclosure.

FIG. 11 is a flowchart illustrating a motion flow of a seventh aspect of the machine operation system according to one embodiment of the present disclosure.

FIG. 12 is a diagram illustrating the seventh aspect of the machine operation system according to one embodiment of the present disclosure.

### DETAILED DESCRIPTION OF EMBODIMENTS OF THE INVENTION

Hereinafter, a machine operation system using wired communication and wireless communication will be described with reference to drawings. The same member is denoted by the same reference sign in each of the drawings. Further, a scale is changed in the drawings as appropriate in order to facilitate understanding. An illustrated aspect is one example for implementation, and the present disclosure is not limited to the illustrated aspect. Further, a “manual operation on a robot or an industrial machine” means that a control device controls a motion of the robot or the industrial machine, based on a command provided from a teaching operation device by operating the teaching operation device.

First, the machine operation system according to one embodiment of the present disclosure will be described.

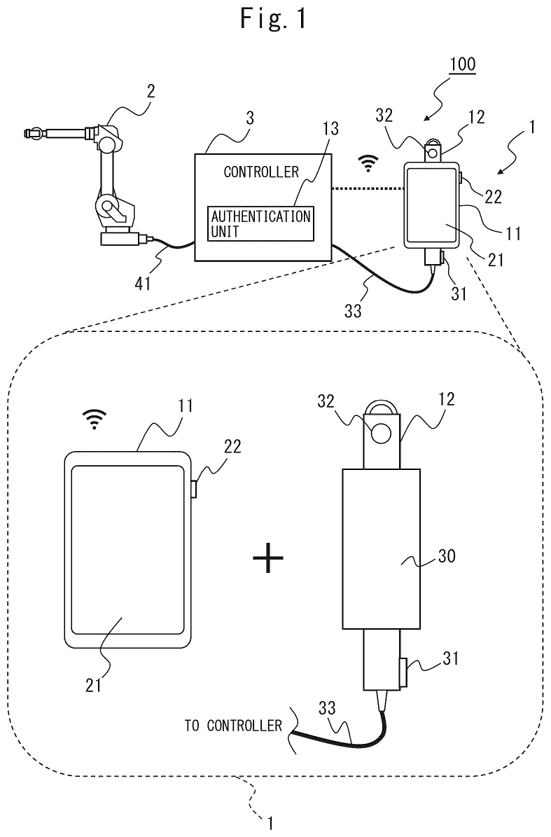

FIG. 1 is a diagram illustrating the machine operation system according to one embodiment of the present disclosure.

As a machine operated by a machine operation system 100 according to one embodiment of the present disclosure, a robot, an industrial machine, or the like is exemplified, but a case where a robot 2 is operated is indicated as one example herein. When a machine operated by the machine operation system 100 is an industrial machine, a term “robot 2” in the following description may be replaced with a term “industrial machine”. For example, a machine tool, forging machinery, an injection molding machine, and the like are included in the industrial machine.

The robot 2 and a control device 3 are communicably connected to each other by a cable 41 (hereinafter referred to as a “robot cable 41”) in a wired manner, and a motion of the robot 2 is controlled by the control device 3. An arithmetic processing device (processor) is provided in the control device 3. As the arithmetic processing device, for example, there are an IC, an LSI, a CPU, an MPU, a DSP, and the like. The control device 3 including the arithmetic processing device is, for example, a functional module achieved by a computer program executed on the processor. For example, when the control device 3 is constituted in a computer program form, the arithmetic processing device is caused to perform a motion according to the computer program, and thus each function for controlling a motion of the robot 2 can be achieved. A computer program for executing processing of the control device 3 may be provided in the form of being recorded in a computer-readable recording medium, such as a semiconductor memory, a magnetic recording medium, or an optical recording medium. Alternatively, the control device may be achieved as a semiconductor integrated circuit to which the computer program that achieves the function is written.

The machine operation system 100 according to one embodiment of the present disclosure includes a wireless operation device 11, a wired operation device 12, and an authentication unit 13. A teaching operation device 1 is formed by combining the wireless operation device 11 and wired operation device 12.

The wireless operation device 11 is, for example, a general-purpose information terminal such as a tablet and a smartphone. The wireless operation device 11 includes, for example, a touch panel 21 having both a screen display function and an input operation acceptance function. As an alternative example, the wireless operation device 11 may include an indicator that performs screen display, and a physical operation button that performs input operation acceptance. Further, the wireless operation device 11 includes a power button 22 for turning on power of the wireless operation device 11. The wireless operation device 11 is activated by the power button 22 pressed (turned on) once. Further, the wireless operation device 11 includes a battery (not illustrated) therein. Charging of the battery of the wireless operation device 11 is performed via a connector or a charging dock (charging stand) with the wireless operation device 11 removed from the wired operation device 12.

A teaching application software program for performing registration, editing, condition setting, and state display of a motion program related to the robot 2, teaching of the robot 2, and the like is installed in a storage unit (not illustrated) located in the wireless operation device 11, and the arithmetic processing device (not illustrated) also located in the wireless operation device 11 performs a motion according to the teaching application software program installed in the storage unit, and thus the wireless operation device 11 achieves a wireless teaching operation function of operating (teaching) the robot 2. As the arithmetic processing device, for example, there are an IC, an LSI, a CPU, an MPU, a DSP, and the like. The storage unit is formed of a non-volatile memory being electrically deletable and recordable such as, for example, an EEPROM (registered trademark), a random access memory that can perform reading and writing at a high speed such as, for example, a DRAM and an SRAM, or the like. The wireless operation device 11 is connected to the control device 3 of the robot 2 via the wireless communication, and includes a communication interface (not illustrated) for the connection. The wireless operation device 11 commands the motion of the robot 2 to the control device 3 in response to an operation content for the wireless operation device 11.

For example, narrow area wireless communication is used as the wireless communication between the wireless operation device 11 and the control device 3. The narrow area wireless communication indicates communication having a communication distance shorter than that of wide area wireless communication, and, specifically, indicates communication having a communication distance of less than 10 meters, for example. Various types of short-range wireless communication having a short communication distance can be used as the narrow area wireless communication, and communication conforming to any communication standard (for example, Wi-Fi (registered trademark), Bluetooth (registered trademark), ZigBee (registered trademark), and the like) established by, for example, IEEE, ISO, IEC, and the like is used. In the illustrated example, a case where the communication conforming to Wi-Fi (registered trademark) is performed is indicated as one example. Further, for example, dedicated short range communication (DSRC), radio frequency identification (RFID), and the like are used as a technique for performing the narrow area wireless communication.

The wired operation device 12 is connected to the control device 3 via the wired communication, and includes a communication interface (not illustrated) for the connection. The wired operation device 12 and the control device 3 are connected to each other via a cable 33 (hereinafter referred to as a “teaching operation device cable 33”). The wired operation device 12 includes an attachment base 30, and an enable switch 31 and an emergency stop button 32 as safety switches.

The attachment base 30 is used for removably attaching the wireless operation device 11 to the wired operation device 12. As an attachment method of the wireless operation device 11 by the attachment base 30, there are, for example, a method for sandwiching the wireless operation device 11 by a spring mechanism provided in the wired operation device 12 and holding the wireless operation device 11, a method for fastening the wireless operation device 11 with a screw, a method for adhering the wireless operation device 11 with an adhering member, and the like. It is noted that, regardless of presence or absence of the attachment of the wireless operation device 11 and the wired operation device 12 by the attachment base 30, there are no direct electrical connection and communication between the wireless operation device 11 and the wired operation device 12, and communication between the wireless operation device 11 and the wired operation device 12 is performed via the control device 3.

The enable switch 31 is a safety switch that permits control of a motion of the robot 2 by the control device 3 via the wireless operation device 11 while pressing (turning on) continues to be performed, and does not permit control of a motion of the robot 2 by the control device 3 via the wireless operation device 11 when pressing (turning on) is released. A signal in response to an operation content for the enable switch 31 is transmitted from the wired operation device 12 to the control device 3 via the teaching operation device cable 33. For example, while the enable switch 31 is not pressed, the robot 2 does not perform a motion even when any operation is performed via the wireless operation device 11. While the enable switch 31 is pressed, the robot 2 can be operated via the wireless operation device 11.

The emergency stop button 32 is a safety switch that commands an emergency stop of the robot 2 to the control device 3. When the emergency stop button 32 is pressed (turned on), an emergency stop signal is transmitted from the wired operation device 12 to the control device 3 via the teaching operation device cable 33, and, in response to this, the robot 2 performs the emergency stop.

In the illustrated example, the authentication unit 13 is provided in the control device 3. As an alternative example, the authentication unit 13 may be provided in the wireless operation device 11 or in the wired operation device 12.

A first operation on the wired operation device 12, and a second operation and a third operation described below on the wireless operation device 11 are operations related to authentication in the machine operation system 100, and are basically distinguished from a normal teaching operation using the wireless operation device 11 and a normal safety operation using the safety switch of the wired operation device 12, but also partially overlap each other.

When the wired operation device 12 and the wireless operation device 11 are in a non-operation state, the wireless operation device 11 does not command a motion of the robot 2 to the control device 3. The authentication unit 13 enables an operation content for the wireless operation device 11 when the first operation on the wired operation device 12 and the second operation on the wireless operation device 11 are performed simultaneously or in a predetermined order after the wired operation device 12 and the wireless operation device 11 are in the non-operation state. Further, the authentication unit 13 disables the operation content for the wireless operation device 11 when execution of the first operation on the wired operation device 12 or the second operation on the wireless operation device 11 ends after the operation content for the wireless operation device 11 is enabled by the first operation on the wired operation device 12 and the second operation on the wireless operation device 11 being performed simultaneously or in the predetermined order. It is noted that an aspect of the operations on the wired operation device 12 and the wireless operation device 11 needed for the authentication by the authentication unit 13 will be described below.

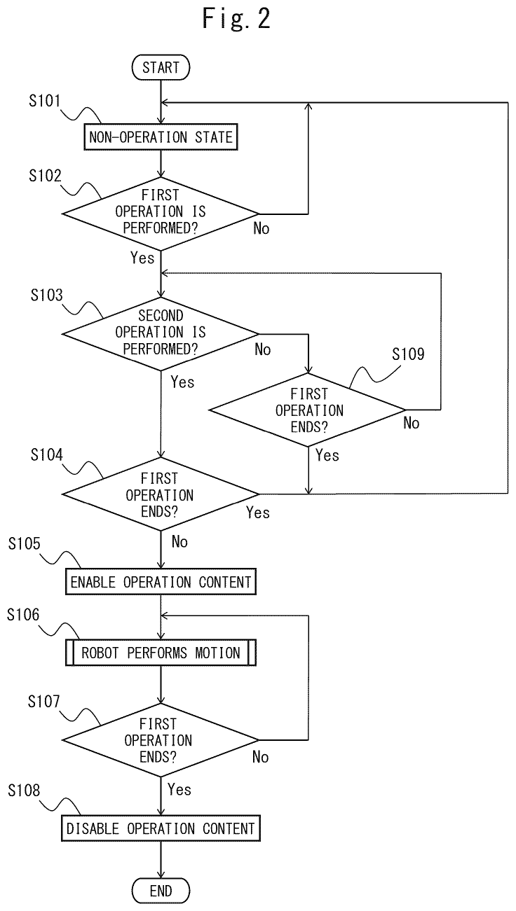

FIG. 2 is a flowchart illustrating a motion flow of the machine operation system according to one embodiment of the present disclosure.

When the wired operation device 12 and the wireless operation device 11 are in a non-operation state in step S101, the wireless operation device 11 does not command a motion of the robot 2 to the control device 3.

In step S102, the authentication unit 13 determines whether the first operation on the wired operation device 12 is performed, based on a signal received from the wired operation device 12. The processing in step S102 is repeatedly performed in a predetermined cycle. In step S102, when it is determined that the first operation on the wired operation device 12 is performed, the processing proceeds to step S103, and, when it is not determined that the first operation on the wired operation device 12 is performed, the processing returns to step S101.

In step S103, the authentication unit 13 determines whether the second operation on the wireless operation device 11 is performed, based on a signal received from the wireless operation device 11. The processing in step S103 is repeatedly performed in a predetermined cycle.

When it is not determined that the second operation on the wireless operation device 11 is performed in step S103, the authentication unit 13 determines whether the first operation on the wired operation device 12 ends, based on a signal received from the wired operation device 12 in step S109. The processing in step S109 is repeatedly performed in a predetermined cycle. In step S109, when it is determined that the first operation on the wired operation device 12 ends, the processing returns to step S101, and, when it is not determined that the first operation on the wired operation device 12 ends, the processing returns to step S103.

When it is determined that the second operation on the wireless operation device 11 is performed in step S103, the processing proceeds to step S104.

In step S104, the authentication unit 13 determines whether the first operation on the wired operation device 12 ends, based on a signal received from the wired operation device 12. The processing in step S104 is repeatedly performed in a predetermined cycle. In step S104, when it is determined that the first operation on the wired operation device 12 ends, the processing returns to step S101, and, when it is not determined that the first operation on the wired operation device 12 ends, the processing proceeds to step S105.

It is noted that step S104 may be omitted. In an example in which step S104 is omitted, when it is determined that the second operation on the wireless operation device 11 is performed in step S103, the processing proceeds to step S105. In other words, in the example in which step S104 is omitted, the first operation is performed once in step S102 and the second operation is performed once in step S103, and thus step S105 is performed.

In step S105, the authentication unit 13 enables an operation content for the wireless operation device 11. In this way, a worker can perform teaching (manual operation) of the robot 2, registration, editing, or condition setting of a motion program related to the robot 2, and the like as a manual operation on the robot 2 using the wireless operation device 11. In response to the manual operation of the wireless operation device 11 by the worker, the control device 3 controls the motion of the robot 2 (step S106). It is noted that, in the processing in step S106, the robot 2 can be operated via the wireless operation device 11 while the enable switch 31 is pressed, and, further, the robot 2 performs an emergency stop when the emergency stop button 32 is pressed.

In step S107, the authentication unit 13 determines whether the first operation on the wired operation device 12 ends, based on a signal received from the wired operation device 12. The processing in step S107 is repeatedly performed in a predetermined cycle. In step S107, when it is determined that the first operation on the wired operation device 12 ends, the processing proceeds to step S108, and, when it is not determined that the first operation on the wired operation device 12 ends, the processing returns to step S106.

It is noted that step S107 may be omitted. In an example in which step S107 is omitted, for example, the processing may automatically proceed to step S108 after a predetermined period of time has elapsed since execution of step S105 has started, and the authentication unit 13 may disable the operation content for the wireless operation device 11.

When it is determined that the first operation on the wired operation device 12 ends in step S107, the authentication unit 13 disables the operation content for the wireless operation device 11 in step S108.

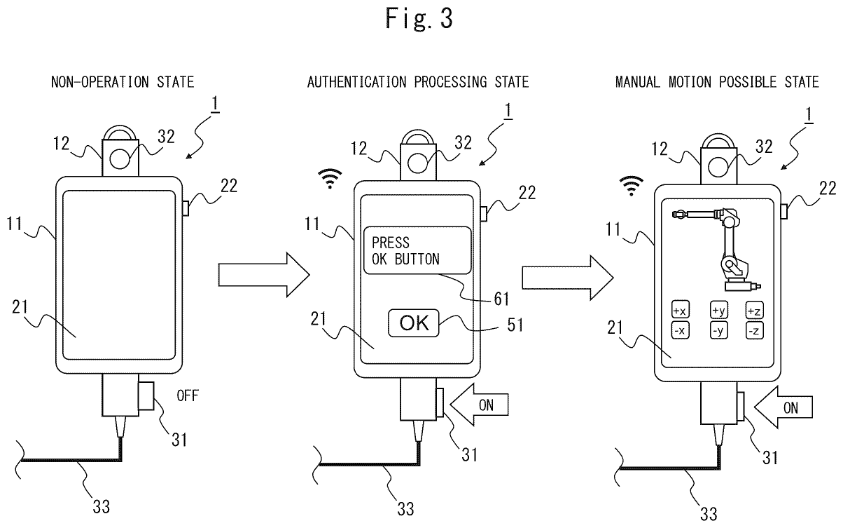

Subsequently, a few aspects of the operations on the wired operation device 12 and the wireless operation device 11 needed for the authentication by the authentication unit 13 are listed. It is noted that, in FIGS. 3 to 6, 8, 10, and 12, a configuration other than the teaching operation device 1 is omitted from the drawing.

FIG. 3 is a diagram illustrating a first aspect of the machine operation system according to one embodiment of the present disclosure. In the first aspect, the first operation on the wired operation device 12 is assumed to be an operation of pressing the enable switch 31, and the second operation on the wireless operation device 11 is assumed to be an operation of pressing an OK button 51 being an enabling button displayed on the touch panel 21.

As illustrated in FIG. 3, in the first aspect, when the wired operation device 12 and the wireless operation device 11 are in a non-operation state, the wireless operation device 11 does not command a motion of the robot 2 to the control device 3. When the operation of pressing the enable switch 31 of the wired operation device 12 is performed as the first operation after the wired operation device 12 and the wireless operation device 11 are in the non-operation state (Yes in step S102 in FIG. 2), the non-operation state shifts to an authentication processing state. In the authentication processing state, by control of the authentication unit 13, a display item 61 that prompts execution of the second operation, such as, for example, “PRESS OK BUTTON”, and the OK button 51 are displayed on the touch panel 21 being an indicator of the wireless operation device 11. When the OK button 51 displayed on the touch panel 21 is pressed once as the second operation while the enable switch 31 is pressed (Yes in step S103 in FIG. 2), the authentication processing state shifts to a manual motion possible state where an operation content for the wireless operation device 11 is enabled (steps S105 and S106). In the manual motion possible state, when a teaching application software program is activated, a manual operation screen for the robot 2 based on the teaching application software program that controls the control device 3 is displayed on the touch panel 21. While the enable switch 31 is pressed, a manual operation of the robot 2 using (the touch panel 21 of) the wireless operation device 11 can be performed. When the enable switch 31 is turned off in the manual motion possible state (Yes in step S107 in FIG. 2), the operation content for the wireless operation device 11 is disabled (step S108 in FIG. 2), control of the motion of the robot 2 by the control device 3 via the wireless operation device 11 is not permitted, and the manual operation of the robot 2 using (the touch panel 21 of) the wireless operation device 11 cannot be performed.

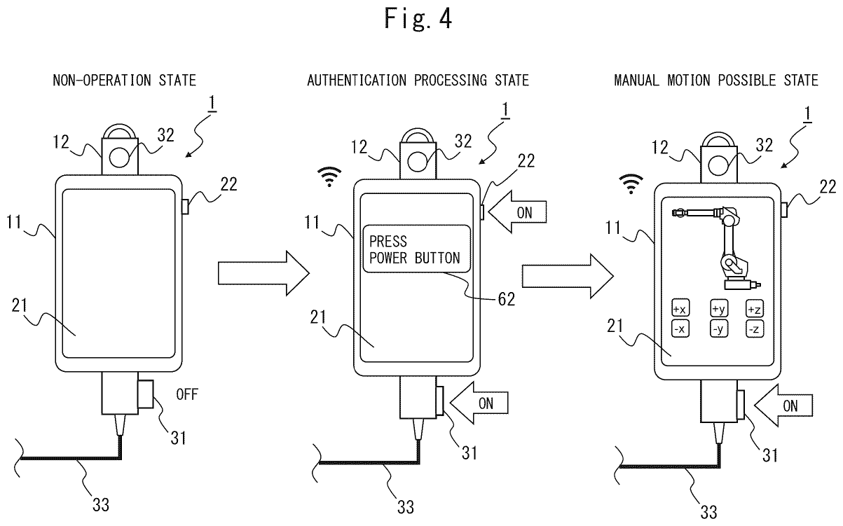

FIG. 4 is a diagram illustrating a second aspect of the machine operation system according to one embodiment of the present disclosure. In the second aspect, the first operation on the wired operation device 12 is assumed to be an operation of pressing the enable switch 31, and the second operation on the wireless operation device 11 is assumed to be an operation of pressing a hardware switch provided in the wireless operation device 11. Herein, as one example, an example in which the hardware switch pressed in the second operation is assumed to be the power button 22 is described, but, for example, pressing of a volume button (not illustrated) may be assumed to be the second operation.

As illustrated in FIG. 4, in the second aspect, when the wired operation device 12 and the wireless operation device 11 are in a non-operation state, the wireless operation device 11 does not command a motion of the robot 2 to the control device 3. When the operation of pressing the enable switch 31 of the wired operation device 12 is performed as the first operation after the wired operation device 12 and the wireless operation device 11 are in the non-operation state (Yes in step S102 in FIG. 2), the non-operation state shifts to an authentication processing state. In the authentication processing state, by control of the authentication unit 13, a display item 62 that prompts execution of the second operation, such as, for example, “PRESS POWER BUTTON”, is displayed on the touch panel 21 being an indicator of the wireless operation device 11. It is noted that the display of the display item 62 may be omitted. When the power button 22 is pressed once as the second operation while the enable switch 31 is pressed (Yes in step S103 in FIG. 2), the authentication processing state shifts to a manual motion possible state where an operation content for the wireless operation device 11 is enabled (steps S105 and S106). In the manual motion possible state, when a teaching application software program is activated, a manual operation screen for the robot 2 based on the teaching application software program that controls the control device 3 is displayed on the touch panel 21. Subsequently, while the enable switch 31 is pressed, a manual operation of the robot 2 using (the touch panel 21 of) the wireless operation device 11 can be performed. When the enable switch 31 is turned off in the manual motion possible state (Yes in step S107 in FIG. 2), the operation content for the wireless operation device 11 is disabled (step S108 in FIG. 2), control of the motion of the robot 2 by the control device 3 via the wireless operation device 11 is not permitted, and the manual operation of the robot 2 using (the touch panel 21 of) the wireless operation device 11 cannot be performed.

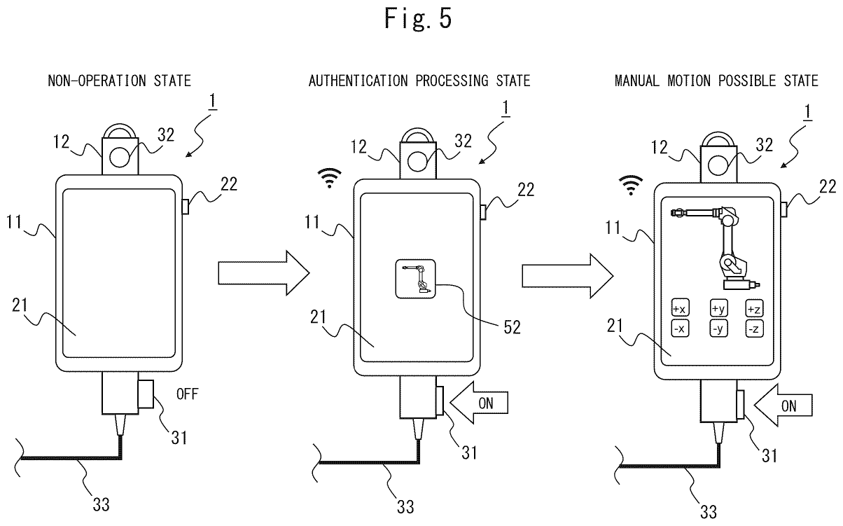

FIG. 5 is a diagram illustrating a third aspect of the machine operation system according to one embodiment of the present disclosure. In the third aspect, the first operation on the wired operation device 12 is assumed to be an operation of pressing the enable switch 31, and the second operation on the wireless operation device 11 is assumed to be an operation of pressing (touching) an activation icon 52 displayed on the touch panel 21 and used for activating a teaching application software program for controlling a control device 3.

As illustrated in FIG. 5, in the third aspect, when the wired operation device 12 and the wireless operation device 11 are in a non-operation state, the wireless operation device 11 does not command a motion of the robot 2 to the control device 3. When the operation of pressing the enable switch 31 of the wired operation device 12 is performed as the first operation after the wired operation device 12 and the wireless operation device 11 are in the non-operation state (Yes in step S102 in FIG. 2), the non-operation state shifts to an authentication processing state. In the authentication processing state, by control of the authentication unit 13, the activation icon 52 for activating the teaching application software program for controlling the control device 3 is displayed on the touch panel 21 being an indicator of the wireless operation device 11. An icon for activating another application software program other than the activation icon 52 may also be displayed on the touch panel 21. When the activation icon 52 displayed on the touch panel 21 is pressed (touched) once as the second operation while the enable switch 31 is pressed (Yes in step S103 in FIG. 2), the teaching application software program is activated, and the authentication processing state also shifts to a manual motion possible state where an operation content for the wireless operation device 11 is enabled (steps S105 and S106). In the manual motion possible state, a manual operation screen for the robot 2 based on the teaching application software program that controls the control device 3 is displayed on the touch panel 21. Subsequently, while the enable switch 31 is pressed, a manual operation of the robot 2 using (the touch panel 21 of) the wireless operation device 11 can be performed. When the enable switch 31 is turned off in the manual motion possible state (Yes in step S107 in FIG. 2), the operation content for the wireless operation device 11 is disabled (step S108 in FIG. 2), control of the motion of the robot 2 by the control device 3 via the wireless operation device 11 is not permitted, and the manual operation of the robot 2 using (the touch panel 21 of) the wireless operation device 11 cannot be performed.

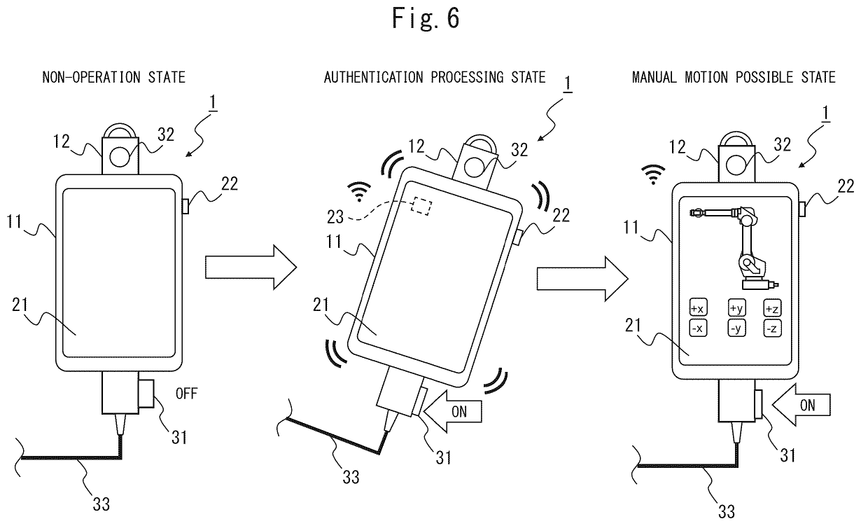

FIG. 6 is a diagram illustrating a fourth aspect of the machine operation system according to one embodiment of the present disclosure. In the fourth aspect, the first operation on the wired operation device 12 is assumed to be an operation of pressing the enable switch 31, and the second operation on the wireless operation device 11 is assumed to be an operation of moving a position and/or a posture of the wireless operation device 11.

As illustrated in FIG. 6, in the fourth aspect, when the wired operation device 12 and the wireless operation device 11 are in a non-operation state, the wireless operation device 11 does not command a motion of the robot 2 to the control device 3. When the operation of pressing the enable switch 31 of the wired operation device 12 is performed as the first operation after the wired operation device 12 and the wireless operation device 11 are in the non-operation state (Yes in step S102 in FIG. 2), the non-operation state shifts to an authentication processing state. In the authentication processing state, the authentication unit 13 determines whether the operation of moving a position and/or a posture of the wireless operation device 11 is performed (step S103 in FIG. 2). The wireless operation device 11 generally includes a sensor 23 such as an acceleration sensor, a magnetic field sensor, a vibration sensor, or an atmospheric pressure sensor therein. A physical movement (change) of a main body of the wireless operation device 11 generated by moving a position and/or a posture of the wireless operation device 11 can be detected by the sensor 23. Examples of the physical movement of the main body of the wireless operation device 11 include a movement of physically moving the wireless operation device 11 to the front and the rear, to the left and the right, and/or up and down, a movement of tilting and flipping the wireless operation device 11, or a movement that combines the above-described movements, a gesture by a worker holding the wireless operation device 11, and the like. The authentication unit 13 determines whether the operation of moving a position and/or a posture of the wireless operation device 11 is performed, based on a signal emitted from the sensor 23. It is noted that, by control of the authentication unit 13, a display item (not illustrated) that prompts execution of the second operation, such as, for example, “MOVE WIRELESS OPERATION DEVICE MAIN BODY”, may be displayed on the touch panel 21 being an indicator of the wireless operation device 11. When a position and/or a posture of the wireless operation device 11 is moved as the second operation while the enable switch 31 is pressed (Yes in step S103 in FIG. 2), the authentication processing state shifts to a manual motion possible state where an operation content for the wireless operation device 11 is enabled (steps S105 and S106). In the manual motion possible state, a manual operation screen for the robot 2 based on a teaching application software program that controls the control device 3 is displayed on the touch panel 21. Subsequently, while the enable switch 31 is pressed, a manual operation of the robot 2 using (the touch panel 21 of) the wireless operation device 11 can be performed. When the enable switch 31 is turned off in the manual motion possible state (Yes in step S107 in FIG. 2), the operation content for the wireless operation device 11 is disabled (step S108 in FIG. 2), control of the motion of the robot 2 by the control device 3 via the wireless operation device 11 is not permitted, and the manual operation of the robot 2 using (the touch panel 21 of) the wireless operation device 11 cannot be performed.

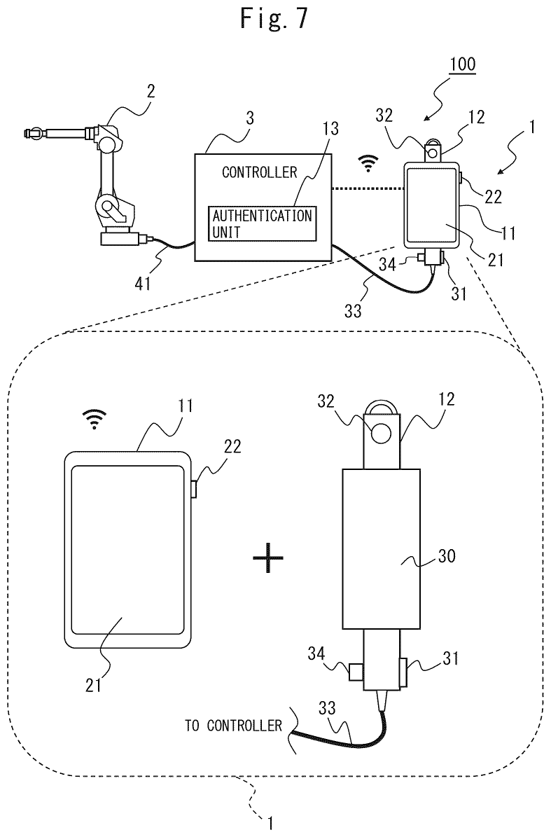

FIG. 7 is a diagram illustrating an authentication button provided in the machine operation system according to one embodiment of the present disclosure.

In the first to fourth aspects, pressing the enable switch 31 is assumed to be the first operation, but, in a fifth aspect, pressing (turning on) an authentication button 34 different from the enable switch 31 is assumed to be the first operation. As illustrated in FIG. 7, in the machine operation system 100, the authentication button 34 is further provided in the wired operation device 12. When the authentication button 34 is pressed, an authentication signal is output from the wired operation device 12. The authentication unit 13 determines presence or absence of the pressing of the authentication button 34, based on presence or absence of reception of the authentication signal. The authentication unit 13 enables an operation content for the wireless operation device 11 when the authentication button 34 is being pressed, and disables the operation content for the wireless operation device 11 when the pressing of the authentication button 34 ends. Alternatively, when the authentication button 34 is pressed once, the operation content for the wireless operation device 11 may be enabled, and, when a predetermined period of time has elapsed since the operation content for the wireless operation device 11 has been enabled, the operation content for the wireless operation device 11 may be disabled. A configuration other than the authentication unit 13 and the authentication button 34 is as described with reference to FIG. 1.

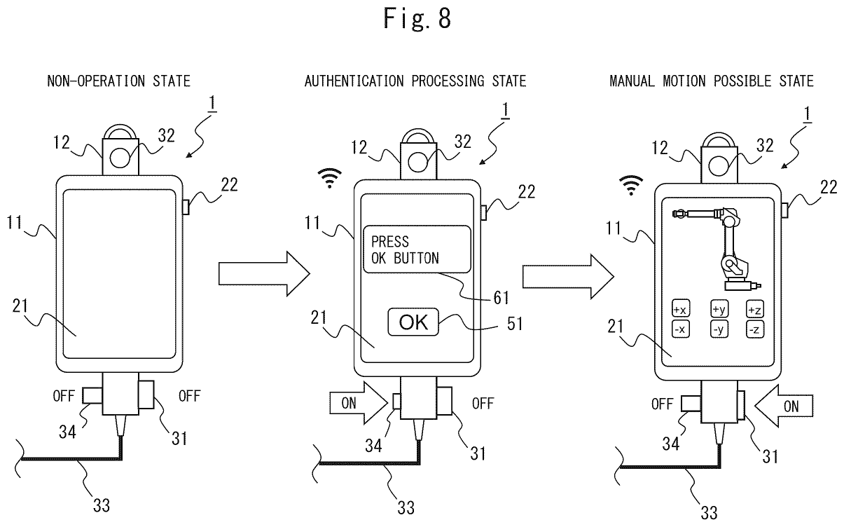

FIG. 8 is a diagram illustrating the fifth aspect of the machine operation system according to one embodiment of the present disclosure.

As illustrated in FIG. 8, in the fifth aspect, when the wired operation device 12 and the wireless operation device 11 are in a non-operation state, the wireless operation device 11 does not command a motion of the robot 2 to the control device 3. When an operation of pressing the authentication button 34 of the wired operation device 12 is performed after the wired operation device 12 and the wireless operation device 11 are in the non-operation state, the non-operation state shifts to an authentication processing state. In the authentication processing state, by control of the authentication unit 13, a display item 63 that prompts execution of the second operation, such as, for example, “PRESS OK BUTTON”, and the OK button 51 are displayed on the touch panel 21 being an indicator of the wireless operation device 11. When the OK button 51 displayed on the touch panel 21 is pressed once as the second operation while the authentication button 34 is pressed, the authentication processing state shifts to a manual motion possible state where an operation content for the wireless operation device 11 is enabled. In the manual motion possible state, when a teaching application software program is activated, a manual operation screen for the robot 2 based on the teaching application software program that controls the control device 3 is displayed on the touch panel 21. Subsequently, while the enable switch 31 is pressed, a manual operation of the robot 2 using (the touch panel 21 of) the wireless operation device 11 can be performed, and, further, when the emergency stop button 32 is pressed, the robot 2 performs an emergency stop. In order to further secure safety, the operation content for the wireless operation device 11 may be disabled when a predetermined period of time has elapsed since the operation content for the wireless operation device 11 has been enabled, and, in this case, control of a motion of the robot 2 by the control device 3 via the wireless operation device 11 is not permitted, and the manual operation of the robot 2 using (the touch panel 21 of) the wireless operation device 11 cannot be performed.

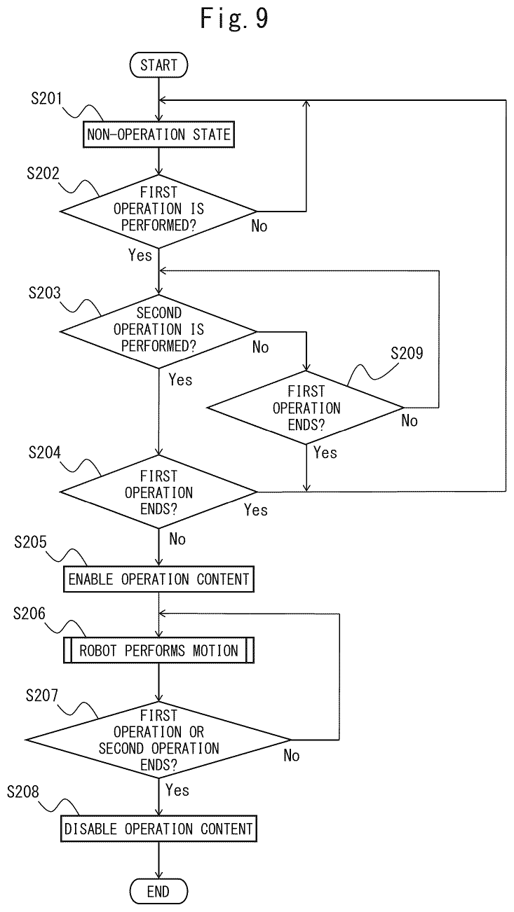

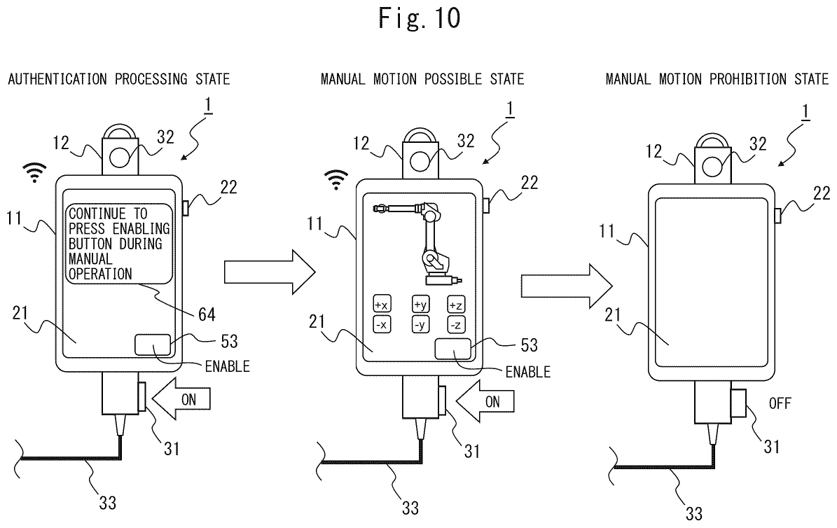

FIG. 9 is a flowchart illustrating a motion flow of a sixth aspect of the machine operation system according to one embodiment of the present disclosure. Further, FIG. 10 is a diagram illustrating the sixth aspect of the machine operation system according to one embodiment of the present disclosure. In the sixth aspect, the first operation on the wired operation device 12 is assumed to be an operation of pressing the enable switch 31, and the second operation on the wireless operation device 11 is assumed to be an operation of pressing an enabling button 53 displayed on the touch panel 21.

When the wired operation device 12 and the wireless operation device 11 are in a non-operation state in step S201, the wireless operation device 11 does not command a motion of the robot 2 to the control device 3.

In step S202, the authentication unit 13 determines whether pressing of the enable switch 31 being the first operation on the wired operation device 12 is performed, based on a signal received from the wired operation device 12. The processing in step S202 is repeatedly performed in a predetermined cycle. When it is determined that the first operation on the wired operation device 12 is performed in step S202, the non-operation state shifts to an authentication processing state, and the processing proceeds to step S203. As illustrated in FIG. 10, in the authentication processing state, by control of the authentication unit 13, a display item 64 that prompts execution of the second operation, such as, for example, “CONTINUE TO PRESS ENABLING BUTTON”, and the enabling button 53 are displayed on the touch panel 21 being an indicator of the wireless operation device 11. When it is not determined that the first operation on the wired operation device 12 is performed in step S202, the processing returns to step S201.

In step S203, the authentication unit 13 determines whether pressing of the enabling button 53 being the second operation on the wireless operation device 11 continues to be performed, based on a signal received from the wireless operation device 11. The processing in step S103 is repeatedly performed in a predetermined cycle.

When it is not determined that the pressing of the enabling button 53 being the second operation on the wireless operation device 11 continues to be performed in step S203, the authentication unit 13 determines whether the pressing of the enable switch 31 being the first operation on the wired operation device 12 ends, based on a signal received from the wired operation device 12 in step S209. The processing in step S209 is repeatedly performed in a predetermined cycle. In step S209, when it is determined that the first operation on the wired operation device 12 ends, the processing returns to step S201, and, when it is not determined that the first operation on the wired operation device 12 ends, the processing returns to step S203.

When it is determined that the second operation on the wireless operation device 11 continues to be performed in step S203, the authentication unit 13 determines whether the pressing of the enable switch 31 being the first operation on the wired operation device 12 ends, based on a signal received from the wired operation device 12 in step S204. The processing in step S204 is repeatedly performed in a predetermined cycle. In step S204, when it is determined that the first operation on the wired operation device 12 ends, the processing returns to step S201, and, when it is not determined that the first operation on the wired operation device 12 ends, the processing proceeds to step S205.

In step S205, the authentication unit 13 enables an operation content for the wireless operation device 11, and the authentication processing state shifts to a manual motion possible state. As illustrated in FIG. 10, in the manual motion possible state, when a teaching application software program is activated, a manual operation screen for the robot 2 based on the teaching application software program that controls the control device 3, and the enabling button 53 are displayed on the touch panel 21. In this way, a worker can perform teaching (manual operation) of the robot 2, registration, editing, or condition setting of a motion program related to the robot 2, and the like as an operation using the wireless operation device 11. In response to the manual operation of the wireless operation device 11 by the worker, the control device 3 controls a motion of the robot 2 (step S206). In the processing in step S206, the robot 2 can be operated via the wireless operation device 11 while the enable switch 31 is pressed and the enabling button 53 is pressed, and, further, the robot 2 performs an emergency stop when the emergency stop button 32 is pressed.

In step S207, the authentication unit 13 determines whether the pressing of the enable switch 31 being the first operation on the wired operation device 12 or the pressing of the enabling button 53 being the second operation on the wireless operation device 11 ends, based on signals received from the wired operation device 12 and the wireless operation device 11. The processing in step S207 is repeatedly performed in a predetermined cycle. In step S207, when it is determined that the first operation on the wired operation device 12 or the second operation on the wireless operation device 11 ends, the processing proceeds to step S208, and, when it is not determined that the first operation on the wired operation device 12 or the second operation on the wireless operation device 11 ends, the processing returns to step S206.

When it is determined that the first operation on the wired operation device 12 or the second operation on the wireless operation device 11 ends in step S207, the manual motion possible state shifts to a manual motion prohibition state, and the authentication unit 13 disables the operation content for the wireless operation device 11 in step S208. As illustrated in FIG. 10, in the manual motion prohibition state, the manual operation screen for the robot 2 based on the teaching application software program, and the enabling button 53 are not displayed on the touch panel 21.

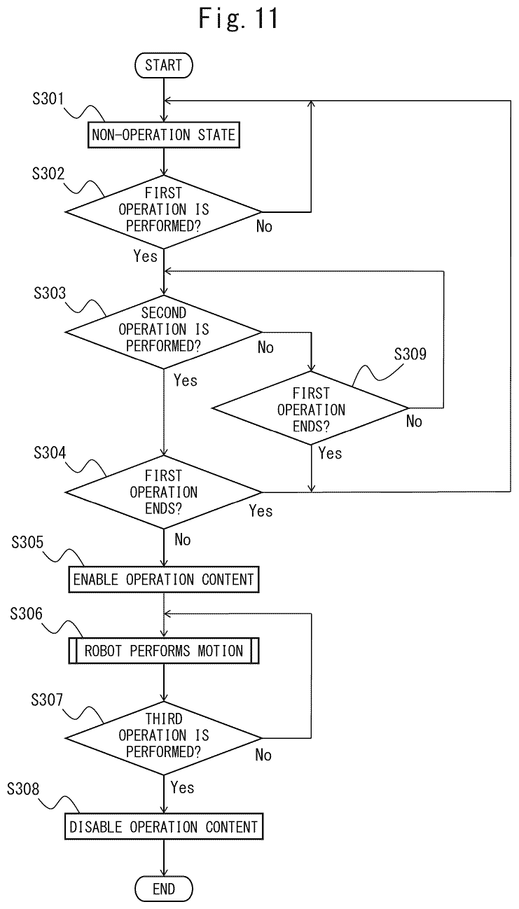

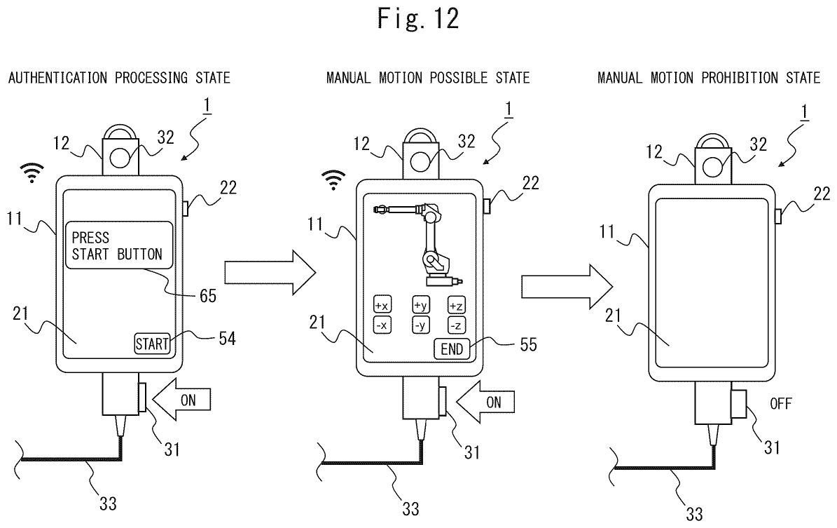

FIG. 11 is a flowchart illustrating a motion flow of a seventh aspect of the machine operation system according to one embodiment of the present disclosure. Further, FIG. 12 is a diagram illustrating the seventh aspect of the machine operation system according to one embodiment of the present disclosure. In the seventh aspect, the first operation on the wired operation device 12 is assumed to be an operation of pressing the enable switch 31, the second operation on the wireless operation device 11 is assumed to be an operation of pressing a start button 54 displayed on the touch panel 21, and, furthermore, the third operation on the wireless operation device 11 for terminating authentication is assumed to be an operation of pressing an end button 55 displayed on the touch panel 21.

When the wired operation device 12 and the wireless operation device 11 are in a non-operation state in step S301, the wireless operation device 11 does not command a motion of the robot 2 to the control device 3.

In step S302, the authentication unit 13 determines whether pressing of the enable switch 31 being the first operation on the wired operation device 12 is performed, based on a signal received from the wired operation device 12. The processing in step S302 is repeatedly performed in a predetermined cycle. When it is determined that the first operation on the wired operation device 12 is performed in step S302, the non-operation state shifts to an authentication processing state, and the processing proceeds to step S303. As illustrated in FIG. 12, in the authentication processing state, by control of the authentication unit 13, a display item 65 that prompts execution of the second operation, such as, for example, “PRESS START BUTTON”, and the start button 54 are displayed on the touch panel 21 being an indicator of the wireless operation device 11. When it is not determined that the first operation on the wired operation device 12 is performed in step S302, the processing returns to step S301.

In step S303, the authentication unit 13 determines whether pressing of the start button 54 being the second operation on the wireless operation device 11 is performed, based on a signal received from the wireless operation device 11. The processing in step S303 is repeatedly performed in a predetermined cycle. When it is determined that the second operation on the wireless operation device 11 is performed in step S303, the processing proceeds to step S304.

When it is not determined that the pressing of the start button 54 being the second operation on the wireless operation device 11 is performed in step S303, the authentication unit 13 determines whether the pressing of the enable switch 31 being the first operation on the wired operation device 12 ends, based on a signal received from the wired operation device 12 in step S309. The processing in step S309 is repeatedly performed in a predetermined cycle. In step S309, when it is determined that the first operation on the wired operation device 12 ends, the processing returns to step S301, and, when it is not determined that the first operation on the wired operation device 12 ends, the processing returns to step S303.

When it is determined that the pressing of the start button 54 being the second operation on the wireless operation device 11 is performed in step S303, the authentication unit 13 determines whether the pressing of the enable switch 31 being the first operation on the wired operation device 12 ends, based on a signal received from the wired operation device 12 in step S304. The processing in step S304 is repeatedly performed in a predetermined cycle. In step S304, when it is determined that the first operation on the wired operation device 12 ends, the processing returns to step S301, and, when it is not determined that the first operation on the wired operation device 12 ends, the processing proceeds to step S305.

In step S305, the authentication unit 13 enables an operation content for the wireless operation device 11, and the authentication processing state shifts to a manual motion possible state. As illustrated in FIG. 12, in the manual motion possible state, when a teaching application software program is activated, a manual operation screen for the robot 2 based on the teaching application software program that controls the control device 3, and the end button 55 are displayed on the touch panel 21. In this way, a worker can perform teaching (manual operation) of the robot 2, registration, editing, or condition setting of a motion program related to the robot 2, and the like as an operation using the wireless operation device 11. In response to the manual operation of the wireless operation device 11 by the worker, the control device 3 controls a motion of the robot 2 (step S306). In the processing in step S306, the robot 2 can be operated via the wireless operation device 11 while the enable switch 31 is pressed, and, further, the robot 2 performs an emergency stop when the emergency stop button 32 is pressed. Further, when the enable switch 31 is turned off, the operation content for the wireless operation device 11 is disabled, control of the motion of the robot 2 by the control device 3 via the wireless operation device 11 is not permitted, and the manual operation of the robot 2 using (the touch panel 21 of) the wireless operation device 11 cannot be performed.

In step S307, the authentication unit 13 determines whether pressing of the end button 55 being the third operation on the wireless operation device 11 is performed, based on a signal received from the wireless operation device 11. The processing in step S307 is repeatedly performed in a predetermined cycle. In step S307, when it is determined that the third operation on the wireless operation device 11 is performed, the processing proceeds to step S308, and, when it is not determined that the third operation on the wireless operation device 11 is performed, the processing returns to step S306.

When it is determined that the third operation on the wireless operation device 11 is performed in step S307, the manual motion possible state shifts to a manual motion prohibition state, and the authentication unit 13 disables the operation content for the wireless operation device 11 in step S308. As illustrated in FIG. 12, in the manual motion prohibition state, the manual operation screen for the robot 2 based on the teaching application software program, the start button 54, and the end button 55 are not displayed on the touch panel 21.

It is noted that the first to fifth aspects described above may be appropriately combined and performed.

Although the case where the machine operated by the machine operation system 100 operates the robot 2 has been described above as one example herein, the description described above can also be similarly applied to a case where a machine operated by the machine operation system 100 is an industrial machine.

According to one embodiment of the present disclosure, in the machine operation system 100 formed of the wireless operation device 11 being a general-purpose information terminal, and the wired operation device 12 being a base member including a safety switch, safety can be secured at a low cost.

According to the machine operation system 100 of one embodiment of the present disclosure, unless the first operation on the wired operation device 12 and the second operation on the wireless operation device 11 are performed simultaneously or in a predetermined order, an operation content for the wireless operation device 11 is not enabled. The wired operation device 12 and the wireless operation device 11 can be removably attached to each other, but the first operation on the wired operation device 12 and the second operation on the wireless operation device 11 can be performed simultaneously or in a predetermined order when a teaching worker simultaneously possesses both of the wired operation device 12 and the wireless operation device 11. Therefore, the teaching worker can operate a safety switch on his/her own decision, and safety is high. Further, a possibility that the safety switch is operated by a third person different from the teaching worker can also be eliminated, and safety is high. Even when the wired operation device 12 and the wireless operation device 11 are separated and located at different places, the teaching worker possesses the wireless operation device 11, and a third person different from the teaching worker possesses the wired operation device 12 and possesses the safety switch, the teaching worker can recognize use of the wired operation device 12 by the third person through, for example, the display items 61 to 65 displayed on the touch panel of the wireless operation device 11 possessed by the teaching worker, and can make it useful for securing his/her own safety. Further, in the machine operation system 100 according to one embodiment of the present disclosure, the existing enable switch 31 provided in the wired operation device 12 can be used, and authentication processing can be achieved by processing on software, and thus a cost is low.

Although the suitable embodiment has been described above, the present invention is not limited to the above-described embodiment, and various alterations and changes can be made within description of the scope of the claims.

### REFERENCE SIGNS LIST

1 Teaching operation device

2 Robot

3 Control device

11 Wireless operation device

12 Wired operation device

13 Authentication unit

21 Touch panel

22 Power button

23 Sensor

30 Attachment base

31 Enable switch

32 Emergency stop button

33 Teaching operation device cable

34 Authentication button

41 Robot cable

51 OK button

52 Activation icon

53 Enabling button

54 Start button

55 End button

61, 62, 63, 64, 65 Display item

100 Machine operation system

1. A machine operation system comprising:
a wireless operation device that is connected to a control device of a robot or an industrial machine via wireless communication, and is able to command a motion of the robot or the industrial machine to the control device;
a wired operation device that is removably attached to the wireless operation device, is connected to the control device via wired communication, and is able to transmit a signal to the control device; and
an authentication unit configured to enable an operation content for the wireless operation device when a first operation on the wired operation device and a second operation on the wireless operation device are accepted simultaneously or in a predetermined order.

2. The machine operation system according to claim 1, wherein
the wireless operation device does not command a motion of the robot or the industrial machine to the control device when the wired operation device and the wireless operation device are in a non-operation state.

3. The machine operation system according to claim 1, wherein
the authentication unit enables an operation content for the wireless operation device when the first operation and the second operation are accepted simultaneously or in a predetermined order after a non-operation state of the wired operation device and the wireless operation device.

4. The machine operation system according to claim 3, wherein
the authentication unit disables an operation content for the wireless operation device when acceptance of the first operation or the second operation ends after an operation content for the wireless operation device is enabled by the first operation and the second operation being accepted simultaneously or in a predetermined order.

5. The machine operation system according to claim 1, wherein
the wireless operation device further includes an indicator that displays a screen for prompting the second operation when the first operation is accepted after a non-operation state of the wired operation device and the wireless operation device, and an operation content for the wireless operation device is enabled when the second operation is accepted while the screen is displayed on the indicator.

6. The machine operation system according to claim 5, wherein
the second operation is an operation of pressing an enabling button displayed on a touch panel for display and input being the indicator.

7. The machine operation system according to claim 5, wherein
the second operation is an operation of pressing an activation icon that is displayed on a touch panel for display and input being the indicator and is used for activating an application software program for controlling the control device.

8. The machine operation system according to claim 1, wherein
the second operation is an operation of pressing a hardware switch provided in the wireless operation device.

9. The machine operation system according to claim 1, wherein
the second operation is an operation of moving a position and/or a posture of the wireless operation device, and
the wireless operation device further includes a sensor for detecting that a position and/or a posture of the wireless operation device is moved.

10. The machine operation system according to claim 3, wherein
the authentication unit disables an operation content for the wireless operation device when a third operation on the wireless operation device is accepted after an operation content for the wireless operation device is enabled by the first operation and the second operation being accepted simultaneously or in a predetermined order.

11. The machine operation system according to claim 3, wherein
the authentication unit disables an operation content for the wireless operation device when a predetermined period of time has elapsed since an operation content for the wireless operation device has been enabled by the first operation and the second operation being accepted simultaneously or in a predetermined order.

12. The machine operation system according to claim 1, wherein
the wired operation device includes an enable switch that permits control of a motion of the robot or the industrial machine by the control device while pressing is performed, and does not permit control of a motion of the robot or the industrial machine by the control device when pressing is released.

13. The machine operation system according to claim 12, wherein
the first operation is an operation of pressing the enable switch.

14. The machine operation system according to claim 1, wherein
the wired operation device includes an authentication button, and
the first operation is an operation of pressing the authentication button.

15. The machine operation system according to claim 1, wherein
the authentication unit is provided in any of the wireless operation device, the wired operation device, and the control device.

16. A method comprising the steps of:
accepting connection with a wireless operation device that is able to transmit a command related to a motion of a robot or an industrial machine;
accepting connection with a wired operation device that is removably attached to the wireless operation device; and
enabling an operation content for the wireless operation device when a first operation on the wired operation device and a second operation on the wireless operation device are accepted simultaneously or in a predetermined order.

17. The method according to claim 16, wherein
the enabling step further includes disabling an operation content for the wireless operation device when acceptance of the first operation or the second operation ends after an operation content for the wireless operation device is enabled by the first operation and the second operation being accepted simultaneously or in a predetermined order.

18. The method according to claim 16, wherein
the second operation is at least any of an operation of pressing an enabling button displayed on an indicator, an operation of pressing an activation icon that is displayed on the indicator and is used for activating an application software program, an operation of pressing a hardware switch provided in the wireless operation device, and an operation of moving a position and/or a posture of the wireless operation device, and
the first operation is an operation of pressing an enable switch provided in the wired operation device, or an operation of pressing an authentication button.

19. The method according to claim 16, further comprising:
a step of displaying, on the indicator, a screen for prompting the second operation when the first operation is accepted; and
enabling an operation content for the wireless operation device when the second operation is accepted while the screen is displayed on the indicator.

20. A control device comprising:
at least one memory; and
at least one processor, wherein
the at least one processor executes the method according to claim 16.

21. A non-transitory computer readable medium storing a computer program for causing at least one computer to execute the method according to claim 16.
